(19) United States
(12) Patent Application Publication
(10) Pub. No.: US 2011/0180581 A1
(43) Pub. Date: Jul. 28, 2011

(54) Resetting and Driving Mechanism for Nail Driving Rod in Pneumatic Nailer having Embedded Air Compressor

(75) Inventors: CHIA-SHENG LIANG, Taipei Hsien (TW); Chu Hsiang Tseng, Taipei Hsien (TW)

(73) Assignee: DE POAN PNEUMATIC CORP.

(21) Appl. No.: 12/692,623

(22) Filed: Jan. 24, 2010

(51) Int. Cl. B25C 1/04

(52) U.S. Cl. 227/8; 227/130

(57) ABSTRACT

A pneumatic nailer includes a main compressed air reservoir, a bottom cylinder chamber, a nail driving rod, an air compressor, a safety rod, and a trigger valve. A resetting and driving mechanism includes a main passage, a first valve member, a startup switch, a power off switch, and an auxiliary passage. The main passage is connected between the main compresses air reservoir and the bottom cylinder chamber. The first valve member is slidably disposed in the main passage and includes an inner end portion for driving the compressed air and an outer end portion for pushing the safety rod. The startup switch is capable of starting the air compressor when the safety rod moves to trigger the startup switch. The power off switch can shut down the air compressor. The auxiliary passage communicates with the main compressed air reservoir and extends to a proximal side of the power off switch.

### BACKGROUND

1. Technical Field

The present invention relates to pneumatic tools, and in particular, to pneumatic nailers.

2. Related Art

Pneumatic nailers are pneumatic tools which utilize compressed air to power the firing of the tools and the driving of the nails. Generally, a pneumatic nailer has a pushable safety sliding pole for controlling the sequence of the operation to drive the nails mounted on a periphery of a body of the pneumatic nailer. The body accommodates several main compressed air reservoirs capable of continuously reserving compressed air and maintaining the pressure of the compressed air, a cylinder, a piston slidably disposed within the cylinder, a nail driving rod integrally connected to a bottom end of the piston, and a trigger valve for driving the nail driving rod to strike the nails therein. The piston divides the cylinder into a top chamber and a bottom chamber.

The user can push the safety sliding pole on a workpiece to be fastened, and press the trigger valve to switch the compressed air passages in the body such that the compressed air enters into the top chamber thereby driving the piston and the nail driving rod connected to the bottom of the piston to move downwardly to strike the nails. Thereafter, the user can release the safety sliding pole and the trigger valve to switch the compressed air passages to exhaust the compressed air in the top chamber and introduce the compressed air into the bottom chamber thereby driving the piston and the piston rod to move upwardly to its original position.

In the conventional technique of reserving compressed air in the main compressed air reservoir, for example, as disclosed in U.S. Pat. No. 7,225,959, an air compressor is embedded in a handle of a pneumatic nailer. The pneumatic nailer utilizes the air compressor to provide compressed air to several main compresses air reservoirs thereby driving the nails. However, the above pneumatic nailer are not connected to a compressed air hose, and thus the user easily mistake there is no compressed air in the main compressed air reservoirs (which is same to the situation that the compressed air hose of the conventional pneumatic nailer with external air compressor is separated), but actually compressed air may exist in the main compressed air reservoirs. As a result, the user easily misestimates whether there is compressed air in the main compressed air reservoirs when the user want to use the pneumatic nailer again and this could be a safety concern. Therefore, there is a desire to overcome aforementioned problems.

### BRIEF SUMMARY

The present invention relates to a resetting and driving mechanism for a nail driving rod in a pneumatic nailer having embedded air compressor which is capable of solving the above safety concern that the user easily misestimates whether there is compressed air in the main compressed air reservoirs after the pneumatic nailer has been used (which means that the nail driving rod is reset to its start position).

The present provides a resetting and driving mechanism for a nail driving rod in a pneumatic nailer having embedded air compressor. The pneumatic nailer includes a body configured therein with a main compressed air reservoir, a bottom cylinder chamber, a nail driving rod, an air compressor, a safety rod, and a trigger valve. The resetting and driving mechanism includes a main passage, a first valve, a startup switch, a power off switch, and an auxiliary passage. The main passage is connected between the main compresses air reservoir and the bottom cylinder chamber. The first valve member is slidably disposed in the main passage and includes an inner end portion for undergoing the driving of the compressed air and an outer end portion for undergoing the pushing of the safety rod. The startup switch is capable of starting the air compressor when the safety rod moves to trigger the startup switch. The power off switch is capable of stopping the air compressor. The auxiliary passage is in communication with the main compressed air reservoir and extends to a proximal side of the power off switch. An auxiliary valve is slidably disposed in the auxiliary passage. The auxiliary passage includes a second valve member and a third valve member. The second valve member is slidably disposed in the auxiliary passage and includes a stopping portion for undergoing the driving of the compressed air. The third valve member is slidably disposed in the auxiliary passage between the second valve member and the power off switch, and includes an air stopping portion for undergoing the driving of the compressed air and a pushing portion for pushing and triggering the power off switch.

In other embodiments of the present resetting and driving mechanism:

The main passage intersects and in communication with the auxiliary passage. The first valve member is slidably disposed at the joint of the main passage and the auxiliary passage such that the first valve connects the bottom cylinder chamber and the auxiliary passage when the first valve member is move from the close state to the open state.

The second valve member is slidably disposed in the auxiliary passage between the main passage and the first valve member, and the third valve member is slidably disposed in the auxiliary passage between the first valve member and the power off switch.

When the user push the safety rod to move upwardly prior to drive the nails the outer end portion is pushed by the safety rod to drive the first valve to close thereby separating the main passage and the bottom cylinder chamber. The startup switch is triggered by the upwardly movement of the safety rod to start the air compressor for reserving compressed air in the main compressed air reservoir. The compressed air in the main compressed air reservoir drives the nail driving rod to move downwardly to strike the nails when the user presses the trigger valve. When the main compressed air reservoir accumulates compressed air therein the stopping portion undergoes the driving of the compressed air thereby opening the second valve member of the auxiliary valve. When the compressed air drives the second valve member to open the air stopping portion of the auxiliary valve undergoes the driving of the compressed air in the auxiliary passage such that the auxiliary valve moves its pushing portion to contact the power off switch to shut down the air compressor. When the user releases the safety rod and the safety rod moves downwardly to reset its position the inner end portion is driven by the compressed air in the main passage to open the first valve such that the compressed air in the main passage flows into the bottom cylinder chamber to drive the safety rod to move upwardly to its start position. The compressed air in the main compressed air reservoir can be exhausted from an exhaust hole formed in the body.

As disclosed above, to overcome the aforementioned problems, the present invention provides a technique of a configuration of the startup switch and the power off switch for controlling (starting and stopping) the timing of providing compressed air into the main compresses air reservoir with the air compressor according to the custom of striking nails. Also, after striking the nails (in other words, after the nail driving rod is reset to its original position), the technique stops to provide compressed air into the main compressed air reservoir and exhausts the compressed air in the main compressed air reservoir (including the cylinder) of the body thereby eliminating the possibility of the compressed air is still reserved in the body. As such, the safety concern that the user may misestimate whether there is compressed air in the main compressed air reservoir is solved.

In addition, the specific technique of the present invention can also include:

The main passage and the auxiliary passage can be respectively arranged at inner portion of a bottom of the body that is adjacent to the safety rod. In this way, the main passage and the auxiliary passage are respectively adjacent to an end edge of an outer wall of the bottom of the body, which is helpful to reduce the complexity of machining the main passage and the auxiliary passage in the body by molding and drilling.

The safety rod moves downwardly to its start position thereby releasing the startup switch, and the startup switch is reset.

A spring is disposed between the second valve member and an inner wall of the auxiliary passage. The spring is pressed when the second valve member is open. The spring is used to drive the second valve member to close such that the auxiliary passage is isolated from the third valve member.

The third valve member releases the power off switch and the power off switch is reset when the compresses air in the auxiliary passage is exhausted.

The startup switch can be disposed at a bottom end of the body, and is on an upwardly moving path of the safety rod for undergoing the pushing of the safety rod.

A trigger is pivotably disposed at a side of the body, and a lug portion is formed on a portion of the trigger that is adjacent to a top of the safety rod. A detention portion is formed on the top of the safety rod. The lug portion swings with the trigger, and is secured to the detention portion moving upwardly with the safety rod thereby braking the downwardly movement of the safety rod. As such, the safety rod can only be reset after releasing the trigger and the pneumatic nailer can be operated in a safe sequence.

A first end portion capable of pushing the outer end portion and a second end portion capable of pushing the startup switch are formed on the top of the safety rod. A spring plate capable of triggering the startup switch is disposed on the second end portion.

In addition, the present invention also provides another specific embodiment differs from the above embodiments in that a pressure sensor for sensing the pressure of the compressed air is disposed in the main compressed air reservoir. The air compressor is stopped when the pressure sensed by the pressure sensor is greater than a specific value. This configuration can be used to replace the above power off switch, the second valve member and the third valve member between the auxiliary passage and the auxiliary valve.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view showing a configuration of an embodiment of the present invention.

FIG. 2 is a cross sectional view taken along the line A-A in FIG. 1.

FIG. 3 is a partially enlarged view of FIG. 1.

FIG. 4 is a partially enlarged view of FIG. 2.

FIG. 5 is a partially enlarged view of FIG. 3.

FIG. 6 is a partially enlarged view of FIG. 4.

FIG. 7 is a circuit diagram of an air compressor, a battery, and a switch of the present invention.

FIG. 8 is an exploded solid view of a safety rod and a trigger of the present invention.

FIG. 9 is a schematic view showing an operation state of FIG. 5.

FIG. 10 is a schematic view showing an operation state of FIG. 3.

FIG. 11 is a schematic view showing an operation state of FIG. 6.

FIG. 12 is a schematic view showing an operation state of FIG. 9.

FIG. 13 is a schematic view showing an operation state of FIG. 10.

FIG. 14 is a schematic view showing an operation state of FIG. 13.

FIG. 15 is a schematic view showing an operation state of FIG. 12.

FIG. 16 is a schematic view showing an operation state of FIG. 11.

FIG. 17 is a schematic view showing an operation state of FIG. 15.

FIG. 18 is a schematic view showing an operation state of FIG. 14.

FIG. 19 is a schematic view showing an extra embodiment of FIG. 1.

FIG. 20 is a circuit diagram of the air compressor, the battery, a pressure sensor, and a startup switch.

### DETAILED DESCRIPTION

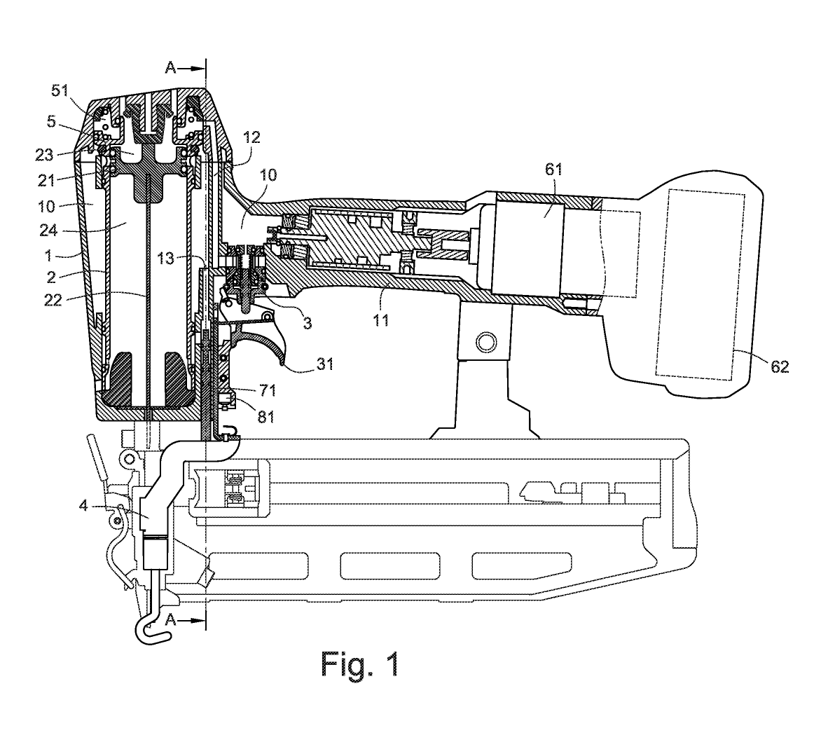

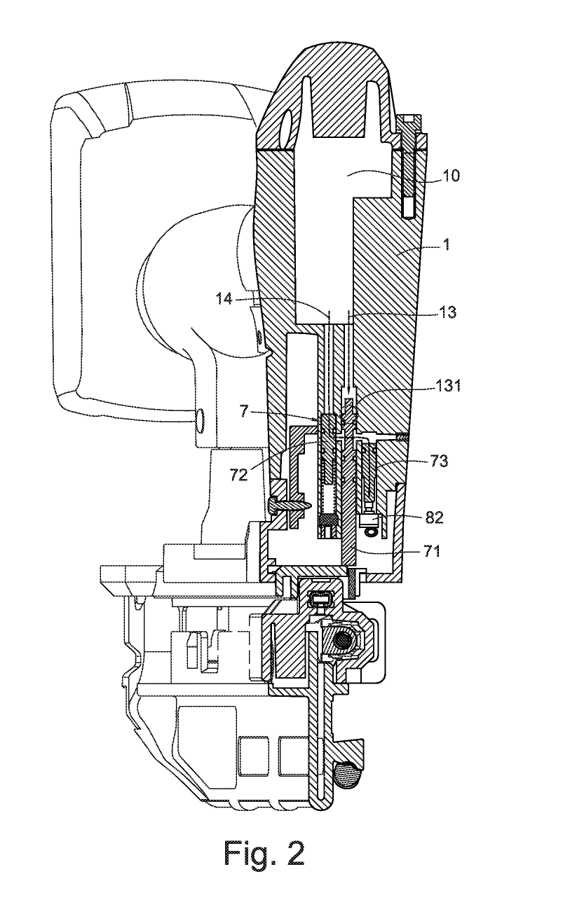

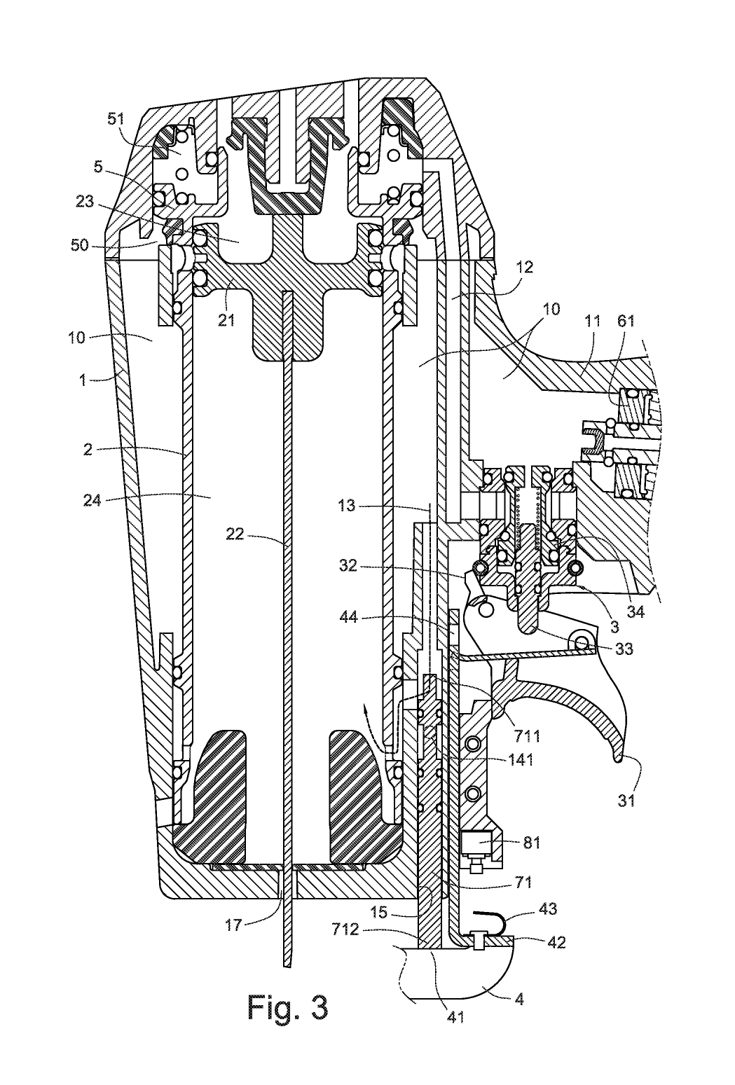

FIG. 1 is a schematic view showing a configuration of an embodiment of the present invention. Referring together FIG. 3, a resetting and driving mechanism for a nail driving rod in a pneumatic nailer having embedded air compressor will be described in accordance with the present invention is disposed in the body 1. A cylinder 2 is disposed in the body 1. In the present embodiment, the cylinder is a movable cylinder, and the cylinder 2 includes a piston 21 slidably assembled to the cylinder 2. A nail driving rod 22 is connected to a bottom of the piston 21. The piston 21 divides an inner space of the cylinder 2 into a top cylinder chamber 23 and a bottom cylinder chamber 24. The body 1 defines several main compressed air reservoirs 10 that are in communication with each other therein (see FIG. 2). The main compressed air reservoirs 10 are distributed between the cylinder 2 in the body 1 and a handle 11. An air compressor 61 and a battery 62 are received in the handle 11. The battery 62 is used to provide electric power to the air compressor 61 thereby driving the air compressor 61 to run. The air compressor 61 forcedly introduces external air into the handle 11 thereby reserving compressed air having a constant pressure in the main compressed air reservoirs 10. A safety rod 4 is slidably mounted on an outer wall of the body 1. A head valve 5 is disposed on a top of the cylinder 2. A trigger valve 3 connected to the main compressed air reservoir 10 is disposed on a portion of the body 1 that is adjacent to the handle 11.

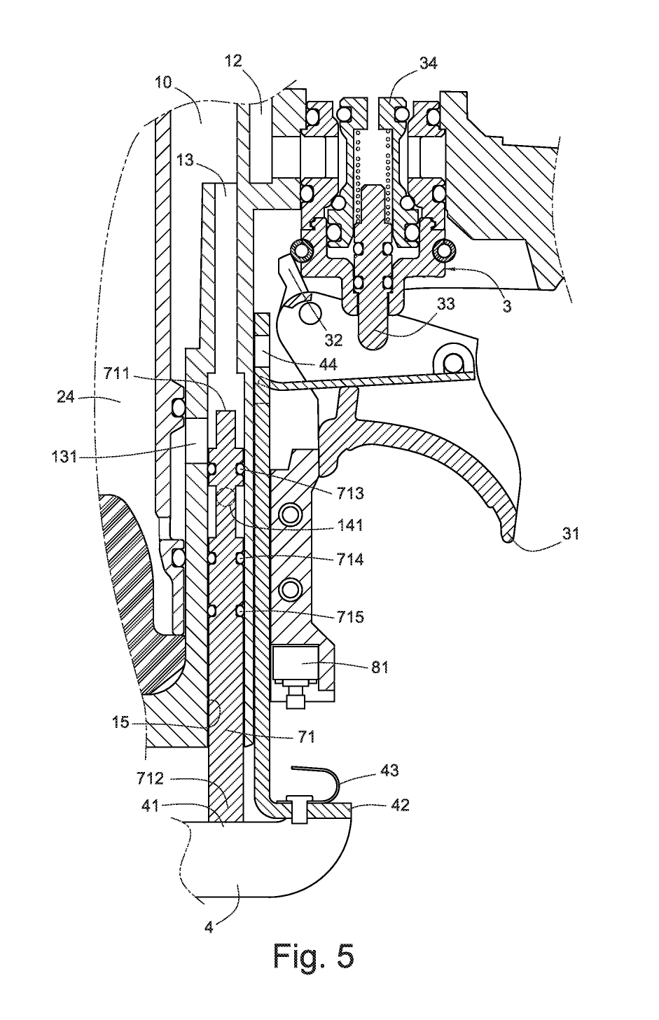

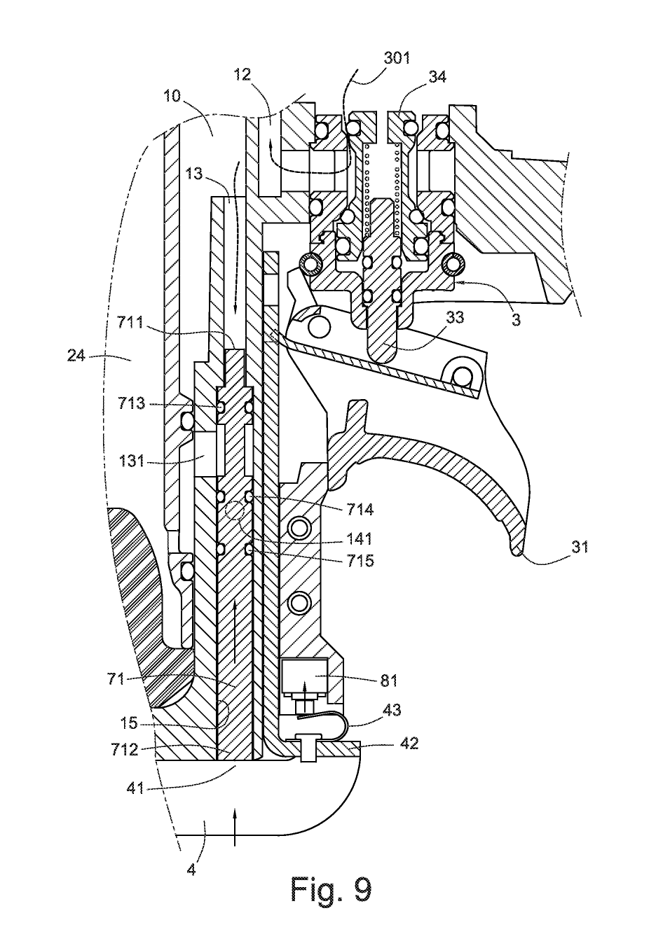

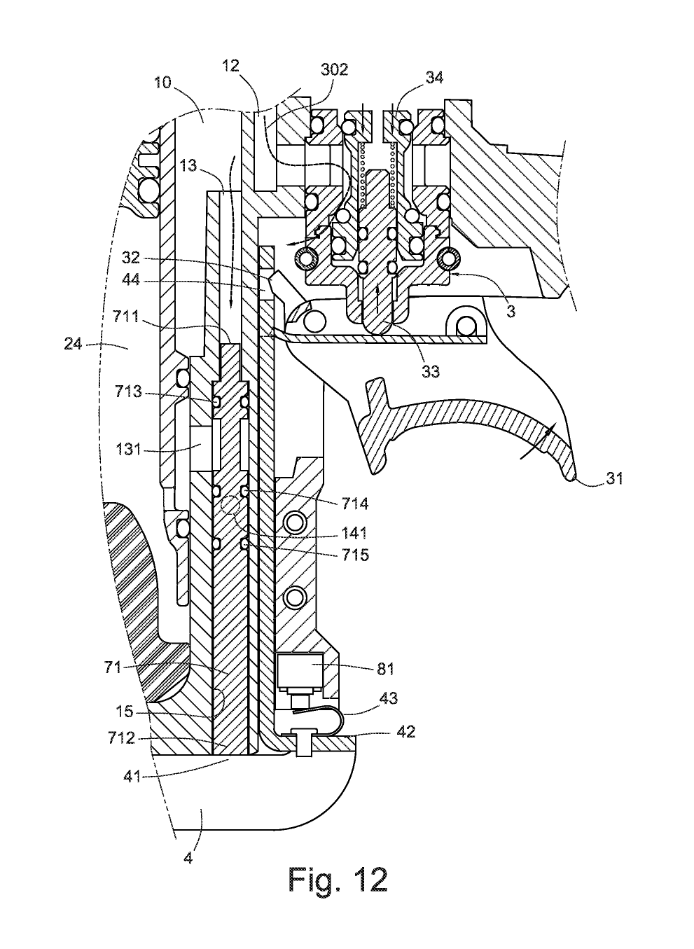

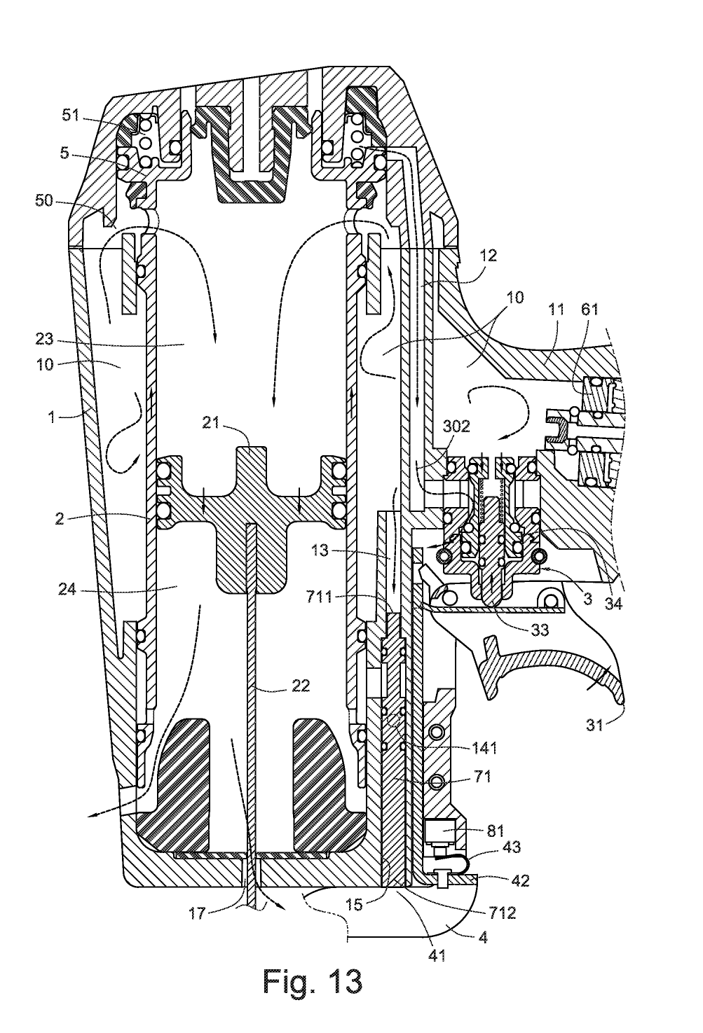

A reservoir 51 (as shown in FIG. 3) is formed between a top inner wall of the body 1 and the head valve. A main valve port 50 (referring to FIG. 13) connecting the main compressed air reservoir 10 to the top cylinder chamber 23 is formed between a periphery of the head valve 5 and an inner wall of the body 1. A trigger 31 (as shown in FIG. 5) adjacent to the trigger valve 3 is pivotably disposed on a side of the body 1. The trigger valve 3 includes a slidably disposed valve bushing 34. A trigger valve stem 33 is slidably disposed in the valve bushing 34. An air introducing passage 301 and an air exhaust passage 302 (referring to FIG. 9 and FIG. 12) that can be switched by the trigger 31 and the trigger valve stem 33 are formed between the valve bushing 34 and an inner wall of the trigger valve 3. A trigger valve passage 12 connecting the reservoir 51 to the trigger valve 3 is formed in the body 1. The air introducing passage 301 connects the main compressed air reservoir 10 and the trigger valve passage 12. The air exhaust passage 302 connects the trigger valve passage 12 to external atmosphere. However, the cylinder 2, the trigger valve 3, the safety rod 4, the head valve 5, the air compressor 61 and the battery 62 are only examples, and can not be limited as above described. In other words, nailers having embedded air compressors and employing other moveable or fixed cylinder, trigger valve, safety rod and head valve to control the driving of the nails can also be used by the present invention.

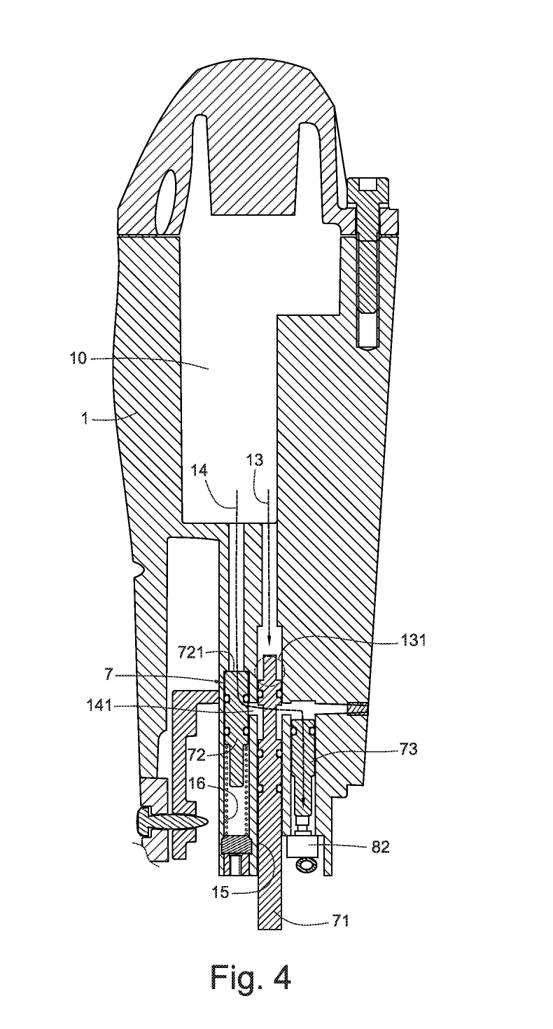

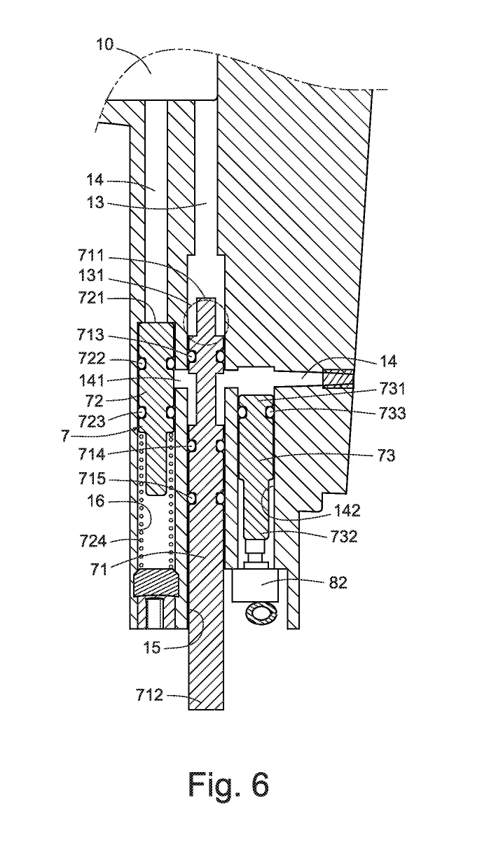

According to above description, in the body 1 of the present invention there are a main passage 13, a cylindrical first valve member 71, a startup switch 81 that is capable of starting the air compressor 61, a power off switch 82 that is capable of stopping the air compressor 61, an auxiliary passage 14, and a valve 7 (referring to FIGS. 1 to 4). The main passage 13 connects between the main compressed air reservoir 10 and the bottom cylinder 24 (as shown in FIG. 5). The auxiliary passage 14 is connected to the main compressed air reservoir 10, and extends to a proximal side of the power off switch 82 (referring to FIG. 6). In the present embodiment, the main passage 13 and the auxiliary passage 14 intersects and in communication with each other. A second valve port 141 is formed at a joint of the main passage 13 and the auxiliary passage 14. At a bottom of the body 1 there is a guide hole 15 connects the joint of the main passage 13 and the auxiliary passage 14 to external atmosphere. The first valve member 71 is disposed in the main passage 13. In the present embodiment, the first valve member 71 is slidably disposed at the joint of the main passage 13 and the auxiliary passage 14, and the guide hole 15. An inner end portion 711 undergoing the driving of the compressed air and an outer end portion 712 undergoing the pushing of the safety rod 4 are respectively formed on a top end and a bottom end of the first valve member 71. The main compressed air reservoir 10 is in communication with the inner end portion 711 via the main passage 13, and the outer end portion 712 is exposed to outside from the guide hole 15 at a position that is at a bottom of the body 1 and capable of undergoing the pushing of the safety rod 4.

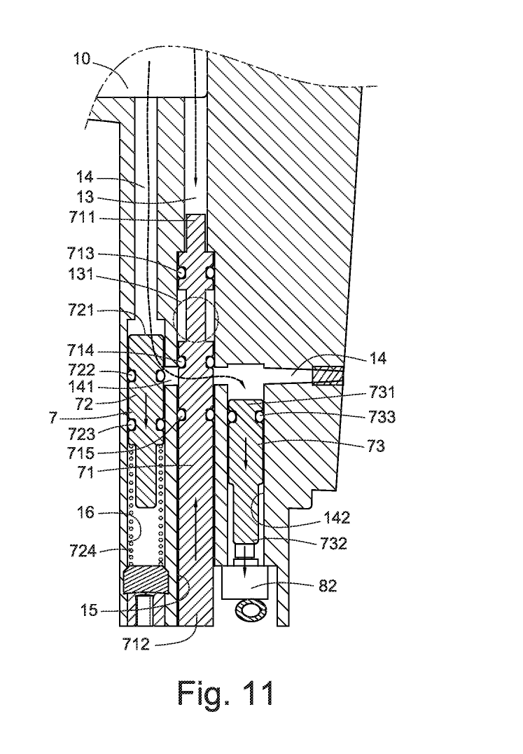

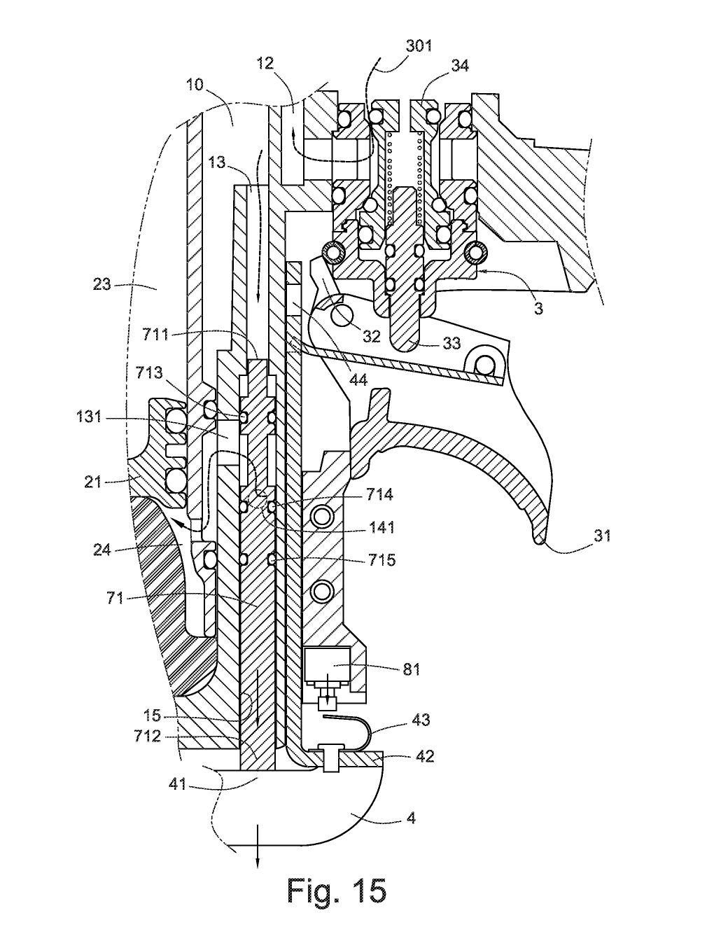

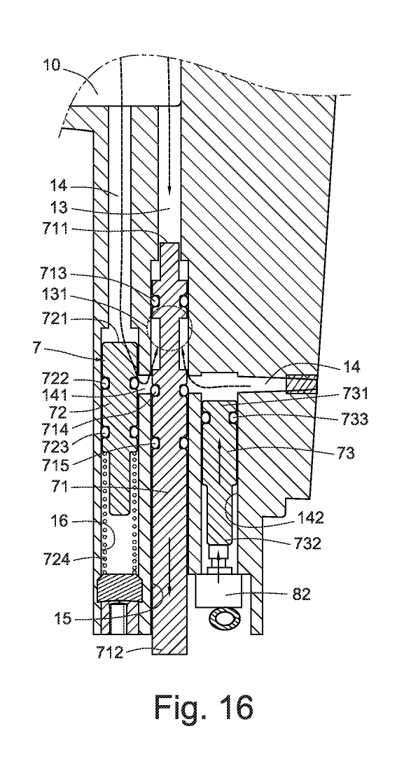

An upper air gasket 713, a middle air gasket 714, and a lower air gasket 715 (as shown in FIG. 5 and FIG. 6) are respectively disposed around the corresponding portion of the outer wall of the first valve member 71. A first valve port 131 is formed at a bending portion of the main passage. When the first valve 71 moves downwardly to a predetermined position that the first valve member 71 is open the upper air gasket 713 moves downwardly with the first valve member 71 to a position below the first valve port 131 to prevent the main passage 13 is communicated to the external atmosphere via the guide hole 15 and connects the main compressed air reservoir 10 to the bottom cylinder chamber 24 via the main passage 13 and the first valve port 131. The middle air gasket 714 moves downwardly with the first valve member 71 to a position below the second valve port 141 thereby preventing the auxiliary passage 14 is communicated to the external atmosphere via the second valve port 141 and the guide hole 15. When the user pushes the safety rod 4 to move upwardly to a predetermined position (as shown in FIG. 9 and FIG. 11), the outer end portion 712 undergoes the pushing of the safety rod 4 to drive the first valve member 71 to move to a predetermined position such that the first valve member 71 is closed and the upper air gasket 713 moves upwardly with the first valve member 71 to a position above the first valve port 131. In this situation, the upper air gasket 713 prevents the main passage 13 from being communicated to the bottom cylinder chamber 24 via the first valve port 131. The middle air gasket 714 moves upwardly with the first valve member 71 to a position between the first valve port 131 and the second valve port 141 at where the middle air gasket 714 prevents the main passage 13 from being communicated with the auxiliary passage 14 via the first valve port 131 and the second valve port 141. Simultaneously, the lower air gasket 715 moves upwardly with the first valve member 71 to a position below the second valve port 141 at where the lower air gasket 715 prevents the second valve port 141 from being communicated with the external atmosphere. During the upwardly and downwardly movement of the first valve member 71 (as shown in FIG. 15 and FIG. 16), the upper air gasket 713 will move with the first valve member 71 to a position above the first valve port 131. At the same time, the middle air gasket 714 moves with the first valve member 71 to pass the downside of the second valve port 141 such that the bottom cylinder chamber 24 is communicated to the auxiliary passage 14 via the first valve port 131 and the second valve port 141 for a moment.

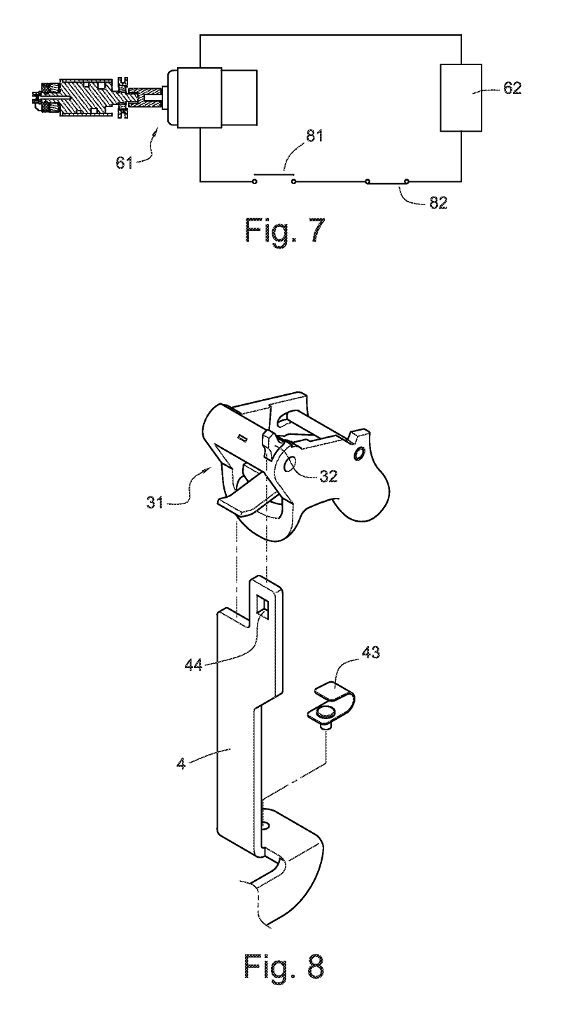

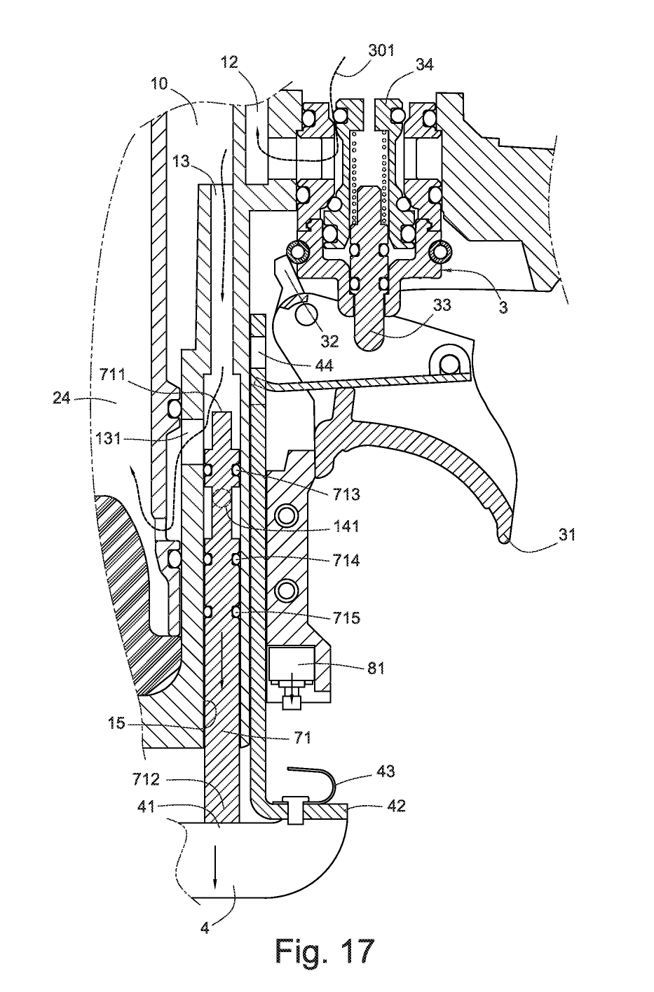

The startup switch 81 is disposed on a bottom end of the body 1 (as shown in FIGS. 1, 3, and 5), and is located on the upwardly moving path of the safety rod 4. The startup switch is capable of undergoing the movement of the safety rod to start. The power off switch 82 is disposed in an inner portion of the bottom end of the body 1 (as shown in FIGS. 3, 4, and 6). In the present embodiment, the startup switch 81 can be a normally opened button switch (referring to FIG. 7) which has elastic rebounding force. The power off switch 82 can be a normally closed button switch which has elastic rebounding force. The startup switch 81 and the power off switch 82 are connected in series between the air compressor 61 and the battery 62 in series. In this manner, if the startup switch 81 is pushed (as shown in FIG. 9) by the safety rod 4 when the power off switch 82 is not triggered the startup switch 81 electrically conducts the battery 62 and the air compressor 61 to start the air compressor 61. The air compressor 61 starts to provide compressed air into the main compressed air reservoir 10 to increases the pressure in the main compressed air reservoir 10. At this time, if the safety rod 4 is moved downwardly to its start position (as shown in FIG. 17) the startup switch 81 is released and reset. The air compressor 61 is disconnected from the battery 62 and thus the air compressor 61 stops working.

The auxiliary valve 7 is slidably disposed on the auxiliary passage (see FIGS. 2, 4, and 6), and includes a cylindrical valve stem shaped second valve member 72 and a cylindrical valve stem shaped third valve member 73. The second valve member 72 is slidably disposed in the auxiliary passage 14, and the third valve member 73 is slidably disposed in the auxiliary passage between the second valve member 72 and the power off switch 82 at a interval from the second valve member 72. In the present embodiment, at the bottom end of the body 1 there is a receiving hole 16 connecting the auxiliary passage 14 to the external atmosphere. The receiving hole 16 is at a side of the guide hole 15. The second valve member 72 is slidably disposed in the auxiliary passage 14 that is between the main compressed air reservoir 10 and the first valve member 71 and the receiving hole 16. A stopping portion 721 for undergoing the driving of the compressed air is formed on a top end of the second valve member 72. The main compressed air reservoir 10 is communicated to the stopping portion 721 via the auxiliary passage 14. A front air gasket 722 and a rear air gasket 723 are respectively disposed around an upper and a lower portion of the outer wall of the second valve member 72. A spring 724 is disposed between the second valve member 72 and an inner wall of the auxiliary passage 14. The spring 724 is substantially disposed between a bottom of the second valve member 72 and the receiving hole 16. The spring 724 is used to drive the second valve member 72 to move upwardly to close the valve such that the front air gasket 722 moves with the second valve member 72 to a position above the second valve port 141. In this situation, the communication between the main compressed air reservoir 10 and the third valve member 73 via the auxiliary passage 14 and the second valve port 141 is closed by the front air gasket 722. Additionally, the rear air gasket 723 moves upwardly with the second valve member 72 to the bottom of the second valve port 141 such that the communication between the second valve port 141 and the external atmosphere via the receiving hole 16 is closed. When the pressure of the compressed air reserved in the main compressed air reservoir 10 exceeds a predetermined constant value, the stopping portion 721 is driven by the compressed air in the auxiliary passage 14 to overcome the spring force of the spring 724. The second valve member 72 moves downwardly to switch to an open state (as shown in FIG. 11) such that the spring 724 is downwardly pressed by the second valve member 72. At the same time, the front air gasket 722 moves downwardly with the second valve member 72 to a position below the second valve port 141 at where the communication between the main compressed air reservoir 10 and the power off switch 82 via the auxiliary passage 14 and the second valve port 141 is opened by the second valve member 72. The rear air gasket 723 is still below the second valve port 141 for closing the communication between the second valve member 141 and the external atmosphere via the receiving hole 16.

A distal end 142 of the auxiliary passage 14 is communicated to the external atmosphere, and the power off switch 82 is disposed in the distal end 142. The valve member 73 of the present embodiment can be slidably disposed at the distal end 142 of the auxiliary passage 14 between the first valve member 71 and the power off switch 82. At the top and bottom ends of the third valve member 73, an air stopping portion 731 for undergoing the driving of the compressed air and a pushing portion 732 for pushing the power off switch 82 are respectively formed. The main compressed air reservoir 10 is communicated with the air stopping portion 731 via the auxiliary passage 14, the second valve member 72, and the first valve member 71. An air gasket 733 is disposed around the outer wall of the third valve member 73 for closing the communication between the auxiliary passage 14 and the external atmosphere via the distal end and the power off switch 82. Because the power off switch 82 has elastic rebounding force and thus the power off switch 82 can upwardly drive the pushing portion 732 so as to drive the third valve member 73 to move upwardly to its start position. At this time, the power off switch 82 maintains the conduction state. When the compressed air in the main compressed air reservoir 10 drives the second valve member 72 via the auxiliary passage 14 to an open state (as shown in FIG. 11), the air stopping portion is driven by the compressed air that enters into the distal end 142 of the auxiliary passage 14 via the second valve portion 141. The third valve member 73 moves downwardly such that the pushing portion 732 pushes the power off switch 82 thereby shutting down the air compressor, and the power off switch is switched to the off state.

In more specific embodiments, the present invention also includes:

A first end portion 41 (see FIGS. 3, and 5) capable of pushing the outer end portion 712 of the first valve member 71, and a second end portion 42 capable of pushing the startup switch 81 is formed on a bending portion at the top of the safety rod 4. A U-shaped spring plate 43 (referring to FIG. 8) capable of triggering the startup switch 81 is disposed on the second end portion 42.

The main passage 13 and the auxiliary passage 14 can be substantially disposed in an inner portion of the bottom of the body 1 that is adjacent to the safety rod, respectively (as shown in FIGS. 1, and 3). In this way, the main passage 13 and the auxiliary passage 14 can be respectively disposed adjacent to an end edge of the outer wall of the bottom of the body 1, which is helpful for reducing the complexity of machining the main passage 13 and the auxiliary passage 14 in the body 1 by molding and drilling.

A lug portion 32 (as shown in FIGS. 3, 5, and 8) is formed on a portion of the trigger 31 that is adjacent to the top of the safety rod 4. A detention portion 44 is formed on the top of the safety rod 4. The detention portion 44 is substantially a cavity, and the lug portion 32 swings with the trigger 31. The lug portion 32 is secured to the detention portion 44 moving upwardly with the safety rod 4 thereby braking the downwardly movement of the safety rod 4. As such, the safety rod 4 can only be reset after releasing the trigger 31 and the pneumatic nailer can be operated in a safe sequence.

According to the structure and arrangement of the above described components, if the user does not push the safety rod to move upwardly and does not press the trigger 31 (as shown in FIGS. 1, 3, and 5) the air compressor 61 is not started, and there is no compressed air in the main compressed air reservoir 10. At this time, the first valve member 71 is kept open, the second valve member 72 is kept closed (as shown in FIGS. 2, 4, and 6), and the startup switch 81 and the power off switch 82 are not triggered. The piston 21 and the nail driving rod 22 are held in the top of the cylinder 2 and under the head valve 5.

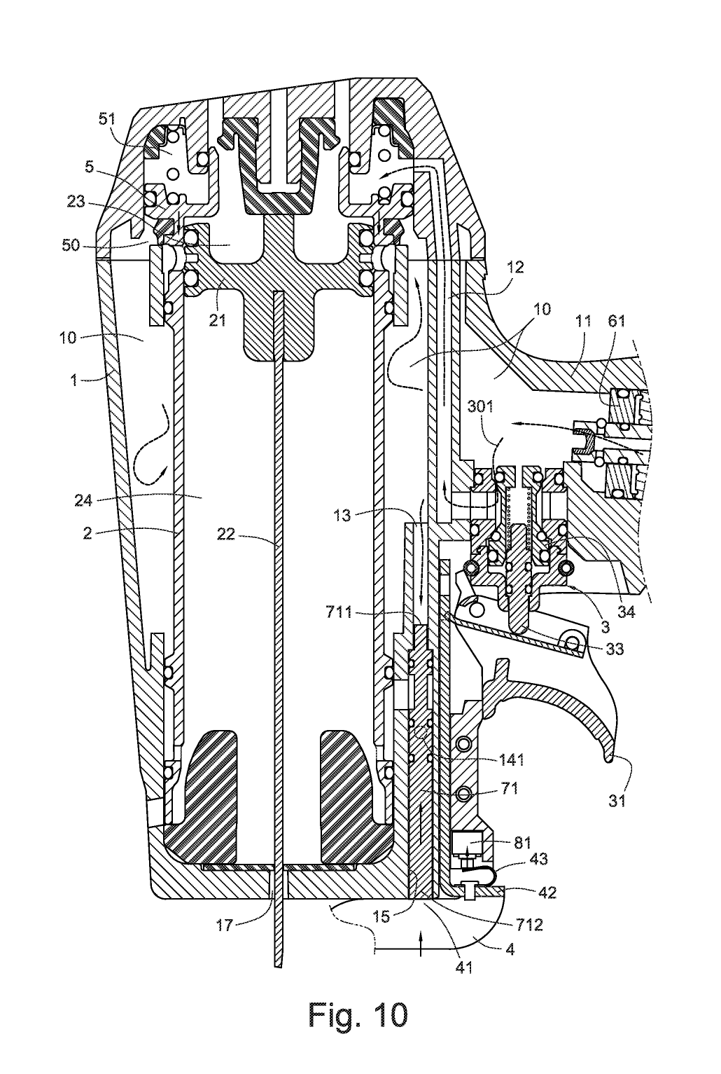

When the user pushes the safety rod 4 to move upwardly (as shown in FIGS. 9 and 10), the first end portion 41 of the safety rod 4 pushes the outer end portion 712 thereby driving the first valve member 71 to move upwardly to close the first valve member. At the same time, the spring plate 43 on the second end portion 42 pushes the startup switch 81 to start the air compressor 61. The air compressor 61 forcedly introduce external air into the handle 11 to reserve compressed air in the main compressed air reservoir 10. At this time, the compresses air in the main compressed air reservoir 10 enters into the reservoir 51 of the head valve 5 via the air introducing passage 301 and the trigger valve passage 12, and the communication between the main compressed air 10 and the bottom cylinder chamber 24 via the main passage 13 and the first valve port 131 is closed by the first valve member 71. The piston 21 and the nail driving rod 22 are still kept in the top of the cylinder 2 and under the head valve.

If the pressure of the compressed air reserved in the main compressed air reservoir 10 reaches to a predetermined constant value, the compressed air downwardly drives the stopping portion 721 (as shown in FIG. 11) via the auxiliary passage 14 to open the second valve member 72 of the auxiliary valve 7. As a result, the compressed air in the auxiliary passage 14 flows to the distal end 142 of the auxiliary passage 14 and downwardly drives the air stopping portion 731 of the auxiliary valve 7. The auxiliary valve 7 moves the pushing portion 732 thereof to downwardly push the power off switch 82 such that the power off switch 82 shuts down the air compressor 61.

After that, the user can press the trigger valve 3 to downwardly drive the nail driving rod 22 to strike the nails (as shown in FIGS. 12, and 13). When the user press the trigger 31 the trigger valve stem 33 is triggered by the trigger 31 and the trigger valve stem 33 drives the valve bushing 34 to open the exhaust passage 302 and close the air introducing passage 301. The compressed air in the reservoir 51 is exhausted to external atmosphere via the trigger valve passage 12 and the exhaust passage 302. The compressed air in the main compressed air reservoir 10 at a periphery of the cylinder 2 drives the head valve 5 and the cylinder 2 to move upwardly to open the main valve port 50. The compressed air in the main compressed air reservoir 10 enters into the top cylinder chamber 23 via the main valve port 50 to drive the piston 21 and the nail driving rod 22 to move downwardly to strike nails. At the same time, by utilizing the operation of the trigger 31, the lug portion 32 swings to be detained by the detention portion 44 thereby braking the downwardly movement of the safety rod.

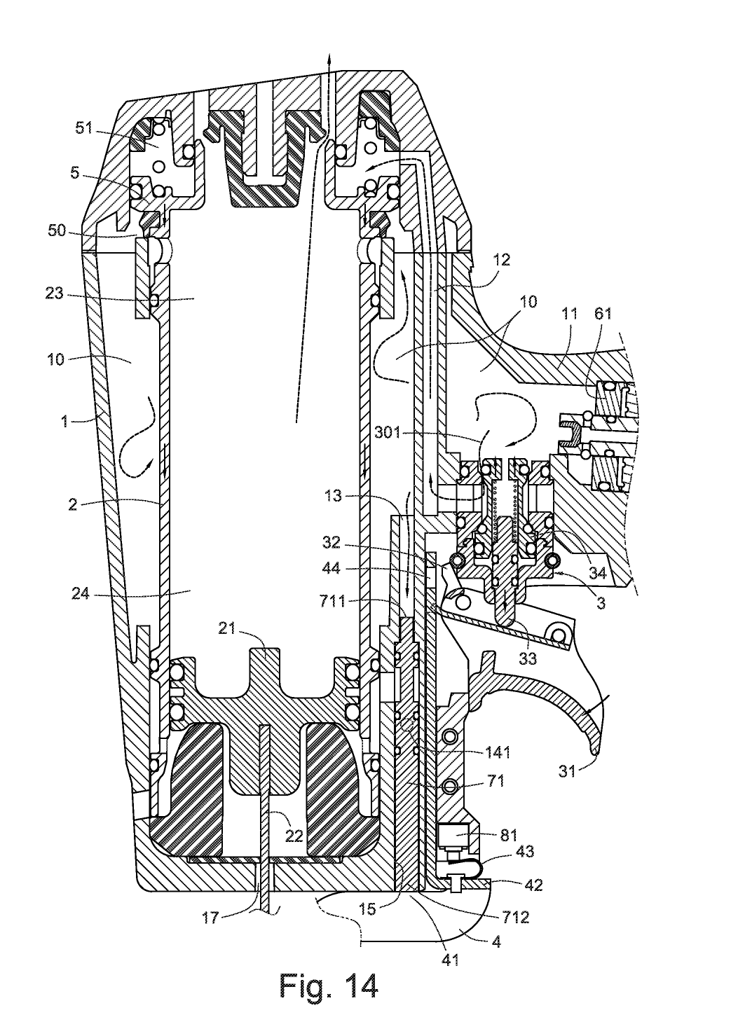

At the moment after the nails are stroke and the user releasing the trigger 31 (as shown in FIG. 14), the lug portion 32 swings to release the detention portion 44. The safety rod 4 moves downwardly. Simultaneously, the trigger 31 releases the trigger valve stem 33 and the trigger valve stem 33 is reset to open the air introducing passage 301 and close the exhaust passage 302. The compressed air in the main compressed air reservoir 10 enters into the reservoir 51 via the air introducing passage 301 and the trigger valve passage 12 to accumulate the pressure for driving the head valve 5 and the cylinder 2 to move downwardly and close the main valve port 50 thereby preventing the compressed air in the main compressed air reservoir 10 enters into the top cylinder chamber 23 via the main valve port 50.

At the moment the user releasing the trigger 31 and the safety rode 4 starting to move downwardly (as shown in FIGS. 15 and 16), the compressed air in the main compressed air reservoir 10 drives the inner end portion 711 via the main passage 13 thereby driving the first valve member 71 to move downwardly. During the period of the state of the first valve member 71 is changed from open to close, the bottom cylinder chamber 24, the first valve port 131, the second valve port 141, and the auxiliary passage 14 are communicated; and thus the compressed air in the main compressed air reservoir 10 enters into the bottom cylinder chamber 24 via the auxiliary passage 14, the second valve port 141, and the first valve port 131. At the same time, the compressed air reserved in the distal end 142 of the auxiliary passage 14 enters into the bottom cylinder chamber 24 through the second valve port 141 and the first valve port 131. As a result, the pushing portion 732 of the auxiliary valve 7 releases the power off switch 82 and the power off switch 82 reboundingly reset its position and drive the third valve member 73 of the auxiliary valve to reset.

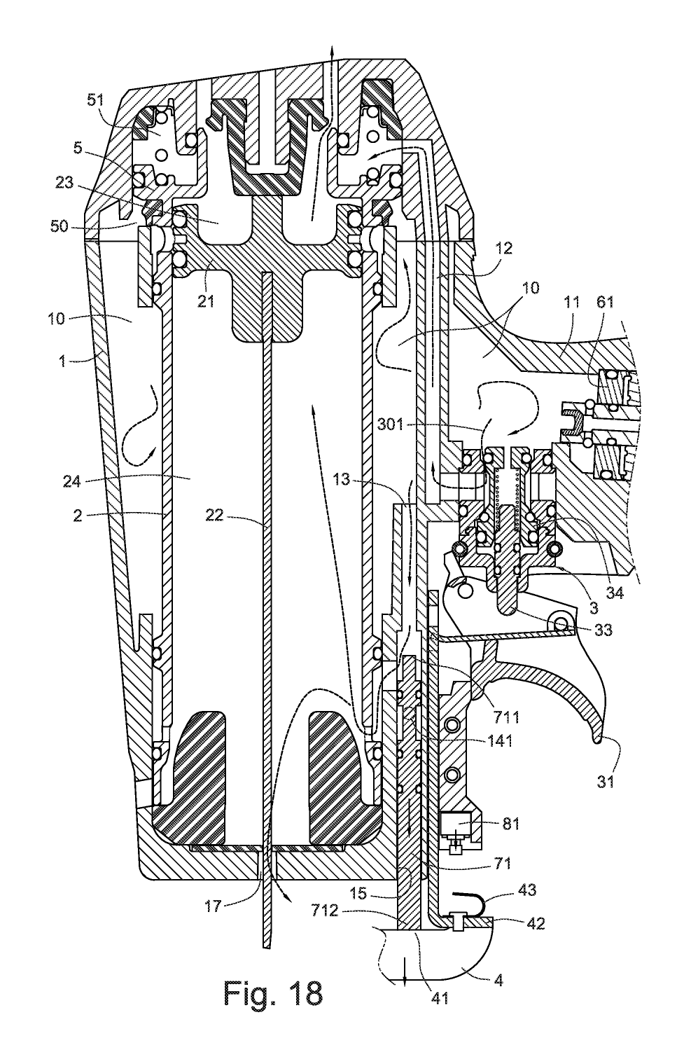

When the safety rod 4 moves downwardly to a predetermined position (as shown in FIGS. 17 and 18) the inner end portion 711 is driven by the compressed air in the main passage 13 to open the first valve member 71 and the communication between the bottom cylinder chamber 23 and the second valve port 141, the auxiliary passage 14 via the first valve port 131 is closed. The compressed air in the main compressed air reservoir 10 enters into the bottom cylinder chamber 24 via the main passage 13 and the first valve port 131 to drive the piston 21 and the nail driving rod 22 to move upwardly to their start position thereby finishing the resetting operation of the nail driving rod 22. During this period, the compressed air in the main compressed air reservoir 10 and the bottom cylinder chamber 24 can be exhausted to the external atmosphere from a vent hole 17 formed at the bottom of the bottom cylinder chamber 24 for guiding the nail driving rod 22 thereby restoring the main compressed air reservoir 10 into its non-reserved state. Then, the second valve member 72 is drive by the spring 724 to move upwardly (as shown in FIG. 6) to close the second valve member 72 of the auxiliary valve 7.

As mentioned above, the present invention provides a technique of a configuration of the startup switch and the power off switch for controlling (starting and stopping) the timing of providing compressed air into the main compresses air reservoir 10 with the air compressor 61 according to the custom of striking nails. Also, after striking the nails (in other words, after the nail driving rod 22 is reset to its original position), the technique stops providing compressed air into the main compressed air reservoir 10 and exhausts the compressed air in the main compressed air reservoir 10 (including the cylinder 2) of the body 1 thereby eliminating the possibility of the compressed air is still reserved in the body 1. As such, the safety concern that the user may misestimate whether there is compressed air in the main compressed air reservoir 10 is solved.

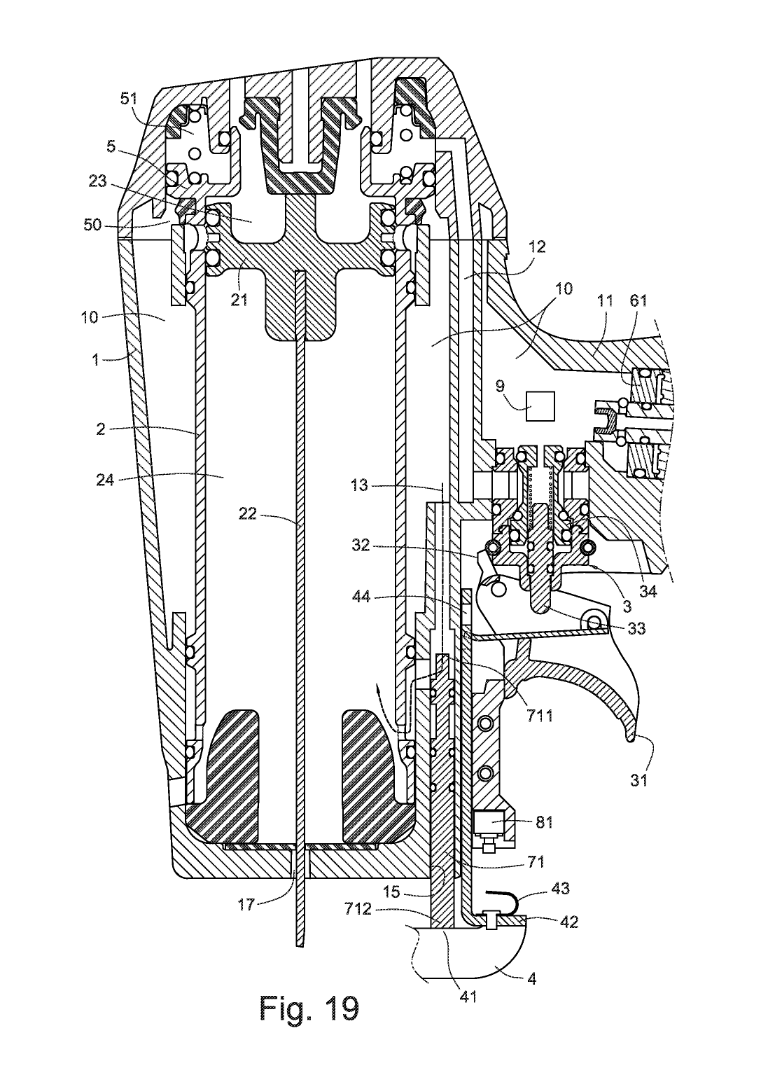

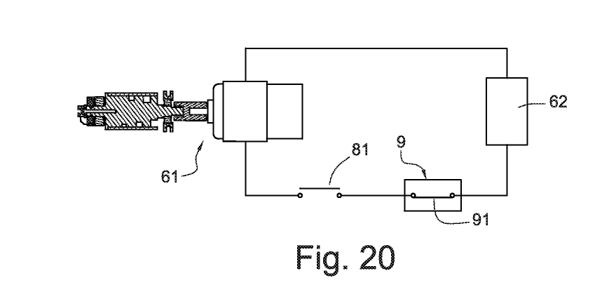

Besides, the present invention also provides another preferred embodiment differing from above embodiments from that a pressure sensor 9 (as shown in FIG. 19) for sensing the pressure of the compressed air is disposed in the main compressed air reservoir 10. In the present embodiment, the pressure sensor can include an outer or an embedded normally closed switch 91 (as shown in FIG. 20). The normally closed switch 91 is connected with the startup switch 81, the air compressor 61, and the battery 62 in series manner. The pressure sensor 9 can open or close the normally closed switch 91 according to the sensed pressure. The air compressor can be shut down when the pressure sensed by the pressure sensor 9 reaches to a specific value. Generally, the compresses air at a pressure in a range from approximately 70 to 120 psi can be used to drive the striking of nails. In the present embodiment, the specific value is 90 psi. Hereby, the pressure sensor 9 can be used to replace the power off switch 82, the auxiliary passage 14, the second valve port 141, the spring 724, and the second valve member 72, the third valve member 73 of the auxiliary valve 7; and the other components can be same to that of the above embodiments.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A resetting and driving mechanism for a nail driving rod in a pneumatic nailer having embedded air compressor, the pneumatic nailer comprising a body configured therein with a main compressed air reservoir, a bottom cylinder chamber, a nail driving rod, an air compressor, and a safety rod, the resetting and driving mechanism comprising:
a startup switch capable of starting the air compressor when the safety rod moves to trigger the startup switch;
a power off switch capable of stopping the air compressor,
a main passage, connected between the main compresses air reservoir and the bottom cylinder chamber, a first valve member being slidably disposed in the main passage and being located on an upwardly moving path of the safety rod, the safety rod being capable of moving upwardly to push the first valve member to a close state thereby blocking the main passage, and push the startup switch to start the air compressor to accumulate compressed air in the main compressed air reservoir for driving the nail driving rod to strike the nails; and
an auxiliary passage, communicated with the main compressed air reservoir, an auxiliary valve being slidably disposed in the auxiliary passage, by driving the auxiliary valve to move with the compressed air in the main compressed air reservoir the auxiliary valve pushing the power off switch to a close state thereby shutting down the air compressor, by downwardly moving the safety rod the compressed air in the main passage driving the first valve member to an open state thereby driving the resetting of the nail driving rod, the compressed air in the main compresses air reservoir and the bottom cylinder chamber can be exhausted from a vent hole formed in the body.

2. The resetting and driving mechanism of claim 1, wherein the auxiliary valve comprises a second valve member and a third valve member slidably disposed in the auxiliary passage, the second valve member undergoing the driving of the compressed air in the main compressed air reservoir to change to an open state thereby driving the third valve member to push the power off switch to a off state to shut down the air compressor.

3. The resetting and driving mechanism of claim 2, wherein the main passage intersects and in communication with the auxiliary passage, the first valve member being slidably disposed at a joint of the main passage and the auxiliary passage such that the first valve connects the bottom cylinder chamber and the auxiliary passage when the first valve member is move from the close state to the open state.

4. The resetting and driving mechanism of claim 2, wherein a spring is disposed between the second valve member and an inner wall of the auxiliary passage, the spring being pressed when the second valve member is open, the spring being used to drive the second valve to switch to a close state thereby preventing the auxiliary passage is communicated with the third valve member.

5. The resetting and driving mechanism of claim 2, wherein the third valve member releases the power off switch to reset the state of the power off switch when the compressed air in the auxiliary passage is exhausted.

6. The resetting and driving mechanism of claim 1, wherein the auxiliary passage is formed at an inner portion of the bottom of the body adjacent to the safety rod.

7. The resetting and driving mechanism of claim 1, wherein the startup switch is disposed on a bottom of the body, and is located on an upwardly moving path of the safety rod, the startup switch undergoing the upwardly pushing of the safety rod.

8. The resetting and driving mechanism of claim 1, wherein the main passage is formed in an inner portion of a bottom of the body adjacent to the safety rod.

9. The resetting and driving mechanism of claim 1, wherein the safety rod moves downwardly to its start position thereby releasing and resetting the startup switch.

10. The resetting and driving mechanism of claim 1, wherein a trigger is pivotably disposed on the body, and a lug portion is disposed on a portion of the trigger that is adjacent to the top of the safety rod, a detention portion being formed on the top of the safety rod, the lug portion swinging with the trigger to be detained the detention portion upwardly moving with the safety rod thereby braking the downwardly resetting movement of the safety rod.

11. A resetting and driving mechanism for a nail driving rod in a pneumatic nailer having embedded air compressor, the pneumatic nailer comprising a body configured therein with a main compressed air reservoir, a bottom cylinder chamber, a nail driving rod, an air compressor, a safety rod, and a trigger valve; the resetting and driving mechanism comprising:
a main passage, connected between the main compresses air reservoir and the bottom cylinder chamber;
a power off switch capable of stopping the air compressor disposed in the body;
an auxiliary passage, communicated with the main compressed air reservoir and extending to a proximal side of the power off switch, the main passage intersecting and in communication with the auxiliary passage;
a first valve member, slidably disposed at a joint of the main passage and the auxiliary passage, the first valve member comprising an inner end portion for undergoing the driving of the compressed air and an outer end portion for undergoing the pushing of the safety rod, when the user pushes the safety rod to move upwardly prior to striking nails the outer end portion being driven by the safety rod to push the first valve member to a closed state thereby closing the communication between the main passage and the bottom cylinder chamber;
a startup switch capable of starting the air compressor when the safety rod moves to trigger the startup switch to provide compressed air for the main compresses air reservoir for driving the nail driving rod to strike nails when the trigger valve is pressed;
a second valve member, slidably disposed in the auxiliary passage, the second valve member comprising a stopping portion for undergoing the driving of the compressed air, when there is reserved compressed air in the main compressed air reservoir the stopping portion is driven by the compressed air in the auxiliary passage to drive the second valve member to a open state; and
a third valve member, slidably disposed in the auxiliary passage between the first valve member and the power off switch at a interval from the second valve member, the third valve member comprising an air stopping portion for undergoing the driving the compressed air and a pushing portion for pushing the power off switch, when the compressed air drives the second valve member to an open state the air stopping portion is driven by the compressed air in the auxiliary passage such that the pushing portion pushes the power off switch to a off state thereby shutting down the air compressor, when the user releasing the safety rod after striking nails the safety rod moving downwardly to reset its position the inner end portion being driven by the compresses air in the main passage to switch the first valve member to a close state thereby conducting the compressed air in the main passage to the bottom cylinder chamber to drive the nail driving rod to move upwardly to reset its position, the compressed air in the main compressed air reservoir and the bottom cylinder chamber being exhausted from a vent hole formed in the body.

12. The resetting and driving mechanism of claim 11, wherein the bottom cylinder chamber is communicated to the auxiliary passage during the period of the first valve member changing from a close state to an open state.

13. The resetting and driving mechanism of claim 11, wherein the auxiliary passage is formed at an inner portion of the bottom of the body adjacent to the safety rod.

14. The resetting and driving mechanism of claim 11, wherein a spring is disposed between the second valve member and an inner wall of the auxiliary passage, the spring being pressed when the second valve member is open, the spring being used to drive the second valve to switch to a close state thereby preventing the auxiliary passage is communicated with the third valve member.

15. The resetting and driving mechanism of claim 11, wherein the third valve member releases the power off switch to reset the state of the power off switch when the compressed air in the auxiliary passage is exhausted.

16. The resetting and driving mechanism of claim 11, wherein the startup switch is disposed on a bottom of the body, and is located on an upwardly moving path of the safety rod, the startup switch undergoing the upwardly pushing of the safety rod.

17. The resetting and driving mechanism of claim 11, wherein the main passage is formed in an inner portion of a bottom of the body adjacent to the safety rod.

18. The resetting and driving mechanism of claim 11, wherein the safety rod moves downwardly to its start position thereby releasing and resetting the startup switch.

19. The resetting and driving mechanism of claim 11, wherein a trigger is pivotably disposed on the body, and a lug portion is disposed on a portion of the trigger that is adjacent to the top of the safety rod, a detention portion being formed on the top of the safety rod, the lug portion swinging with the trigger to be detained the detention portion upwardly moving with the safety rod thereby braking the downwardly resetting movement of the safety rod.

20. The resetting and driving mechanism of claim 11, wherein a first end portion capable of pushing the outer end portion and a first end portion capable of pushing the startup switch are formed on the top of the safety rod.

21. The resetting and driving mechanism of claim 20, wherein a spring plate capable of triggering the startup switch is disposed on the second end portion.

22. A resetting and driving mechanism for a nail driving rod in a pneumatic nailer having embedded air compressor, the pneumatic nailer comprising a body configured therein with a main compressed air reservoir, a bottom cylinder chamber, a nail driving rod, an air compressor, and a safety rod; the resetting and driving mechanism comprising:
a startup switch capable of starting the air compressor when the safety rod moves to trigger the startup switch;
a main passage, connected between the main compresses air reservoir and the bottom cylinder chamber, a first valve member being slidably disposed in the main passage and being located on an upwardly moving path of the safety rod, the safety rod being capable of moving upwardly to push the first valve member to a close state thereby blocking the main passage, and push the startup switch to start the air compressor to accumulate compressed air in the main compressed air reservoir for driving the nail driving rod to strike the nails;
a pressure sensor disposed in the main compressed air reservoir for sensing the pressure of the compresses air, when the safety rod moves downwardly the compressed air in the main passage drives the first valve member to an open state such that the nail driving rod moves upwardly to reset its position, the air compressor being shut down when the pressure in the main compressed air reservoir sensed by the pressure sensor reaches to a specific value, the compressed air in the main compressed air reservoir and the bottom cylinder chamber being exhausted from a vent hole formed in the body.

23. The resetting and driving mechanism of claim 22, wherein the startup switch is disposed on a bottom of the body, and is located on an upwardly moving path of the safety rod, the startup switch undergoing the upwardly pushing of the safety rod.

24. The resetting and driving mechanism of claim 22, wherein the main passage is formed in an inner portion of a bottom of the body adjacent to the safety rod.

25. The resetting and driving mechanism of claim 22, wherein the safety rod moves downwardly to its start position thereby releasing and resetting the startup switch.

26. The resetting and driving mechanism of claim 22, wherein a trigger is pivotably disposed on the body, and a lug portion is disposed on a portion of the trigger that is adjacent to the top of the safety rod, a detention portion being formed on the top of the safety rod, the lug portion swinging with the trigger to be detained the detention portion upwardly moving with the safety rod thereby braking the downwardly resetting movement of the safety rod.
